(19) United States
(12) Patent Application Publication
(10) Pub. No.: US 2023/0415063 A1
(43) Pub. Date: Dec. 28, 2023

(54) MODULAR HORIZONTAL TUBE EVAPORATOR UNIT, CLEANING DEVICE, EVAPORATOR AND CLEANING APPLICATION METHOD

(71) Applicant: JIANGSU KUNYEE ENVIRONMENTAL TECHNOLOGY CO., LTD., Wuxi (CN)

(72) Inventors: Fangyue LI, Wuxi (CN); Junying XIE, Wuxi (CN); Chen CHEN, Wuxi (CN)

(73) Assignee: JIANGSU KUNYEE ENVIRONMENTAL TECHNOLOGY CO., LTD., Wuxi (CN)

(21) Appl. No.: 18/046,908

(22) Filed: Oct. 15, 2022

(30) Foreign Application Priority Data
Jun. 22, 2022 (CN) 202210710221.2

(51) Int. Cl. B01D 1/30; C02F 1/04; B01D 1/04; B01D 1/20; C02F 1/12; B08B 9/023; F28G 1/16; C11D 11/00; C11D 17/00; C11D 3/37

(52) U.S. Cl. CPC B01D 1/30; C02F 1/043; B01D 1/04; B01D 1/20; C02F 1/12; B08B 9/023; F28G 1/166; C11D 11/0041; C11D 17/0013; C11D 3/3773; C02F 2201/007; C02F 2303/14; C02F 2201/004; C02F 2303/22; B08B 2209/02

(57) ABSTRACT

The invention provides a modular horizontal tube evaporator unit, which is characterized in that the modular horizontal tube evaporator unit at least includes a modular heat exchange part designed based on a specific technical parameter, a modular tube box, and a modular quick connect device. The invention also provides an evaporator based on the modular horizontal tube evaporator unit, a cleaning device for the modular evaporator unit, and a cleaning application method thereof.

### TECHNICAL FIELD

The invention relates to the technical field of sewage treatment, in particular to a modular unit of a modular horizontal tube evaporator, a cleaning device, a modular horizontal tube evaporator and a cleaning application method.

### BACKGROUND TECHNOLOGY

The horizontal tube evaporator is widely used in seawater desalination, garbage leachate concentration, and high salt wastewater concentration. When treating these high concentration wastewaters, the surface of the heat exchange tube of the evaporator is prone to scaling. After scaling on the surface of the heat exchange tube, the heat exchange coefficient of the evaporator decreases. As the scale thickness increases, the heat exchange coefficient will deteriorate significantly, resulting in low concentration efficiency, high energy consumption, and high operating costs, therefore, the heat exchange tubes in the evaporator need to be descaled frequently and regularly.

The existing descaling methods are roughly divided into cleaning liquid flow cleaning and mechanical descaling.

The heat exchange tubes of the traditional horizontal tube evaporator are horizontally arranged inside the long cylinder and welded to the tube plates at both ends of the evaporation cylinder. The distance between the heat exchange tubes is relatively small, and the heat exchange tubes are densely formed into a whole. The gap between the heat exchange tubes is generally between 10 mm and 20 mm, and the heat exchange tubes cannot be disassembled after manufacturing. When the heat exchange tubes are scaled, the general treatment method is to wash from top to bottom by spraying the reagent solution through the nozzle inside the cylinder. Even if some areas inside the cylinder can be washed with a high-pressure water gun, due to the narrow space inside the evaporator cylinder, the high-pressure water gun is also difficult to clean in depth, and the cleaning scope is very limited, especially the heat exchange tube at the lower layer of the horizontal tube evaporator.

Another disadvantage of this spray type automatic descaling cleaning method is that the evaporator needs to be shut down for a long time for cleaning and descaling. If a separate cleaning and spraying system is set, the space congestion in the evaporator cylinder will be further aggravated. If the existing sewage spraying system in the evaporator cylinder is used, the spraying pipeline needs to be switched between the sewage and cleaning fluid supply systems and repeatedly flushed, resulting in time-consuming, laborious, high energy consumption, the unfavorable situation of low utilization rate of equipment.

Mechanical descaling includes real-time online descaling compared with the cleaning solution cleaning method. However, for the traditional horizontal tube evaporator, the descaling device is set on the thin and dense heat exchange tube bundle, and the interference of the tube bundle support to the movement of the descaling device needs to be considered. These technical difficulties will lead to the technical defects of the descaling device and its transmission mechanism, which are complex in structure and difficult to control the movement trajectory, this mechanical descaling technology has high production, assembly and operation costs, poor descaling effect, low operation reliability, easy failure, high maintenance cost and great difficulty.

### SUMMARY OF THE INVENTION

In view of the defects and deficiencies in the prior art, the present invention aims to provide a modular horizontal tube evaporator unit, which can be used to realize the expansion and assembly of “building block” evaporators and facilitate the selection of “self-service” evaporators and the adjustment of working power of evaporators.

Another purpose of the invention is to provide a cleaning device, which is matched with the said modular horizontal tube evaporator unit and can provide fast and efficient cleaning and descaling of heat exchange tubes.

Another purpose of the invention is to provide an evaporator based on the modular horizontal tube evaporator unit described above. Using the modular horizontal tube evaporator unit of the invention, the expansion and assembly of the “building block” heat exchange unit of the evaporator can be realized, giving the evaporator the convenience of “self-service” selection and adjusting the working power of the evaporator.

Another purpose of the invention is to provide a fast and efficient method for cleaning heat exchange tubes, which is similar to cleaning and descaling the evaporator without stopping the machine, and has simple structure, high efficiency and convenience, significantly improving the effective operation time of the evaporator and improving the production efficiency.

The technical solution of the invention includes:

A modular horizontal tube evaporator unit, which is characterized in that the modular horizontal tube evaporator unit at least includes
Modular heat exchange part, at least one tube plate is respectively arranged at both ends of the modular heat exchange part, a group of tube holes are arranged on the tube plates at both ends of the heat exchange part, the heat exchange part also includes a group of heat exchange tubes, and both ends of the heat exchange tubes are respectively arranged in the tube holes;
A modular header is arranged at one or both ends of the modular heat exchange part, and at least a steam inlet and a condensate and/or residual steam outlet are arranged on the modular header;
The modular quick connection device is used to connect the modular header and the tube sheet of the modular heat exchange part connected with the modular quick connection device.

As a preferred embodiment, the specific technical parameters include any one or two or three of the heat transfer power or axial length or maximum radial dimension.

As a preferred embodiment, the modular horizontal tube evaporator unit includes a single modular header mode, the single modular header is set at one end of the modular heat exchange part, and the inner cavity of the modular header is sealed and isolated as a steam inlet part and a steam outlet part; The heat exchange tube ends at the other end of the modular heat exchange part are respectively connected through a group of connecting tubes, and the two connected heat exchange tubes form a new U-shaped heat exchange tube, and the two ports of all U-shaped heat exchange tubes are respectively located in the steam inlet part and the steam outlet part; The steam inlet is arranged on the wall of the steam inlet part of the modular header, and the condensate and/or residual steam outlet are arranged on the wall of the steam outlet part.

As a preferred embodiment, the modular evaporator unit includes a dual modular header mode, which is respectively set at both ends of the modular heat exchange part. One header is a steam inlet header, which is set with the steam inlet, and the other is a steam outlet header, which is set with the condensate and/or residual steam outlet.

As a preferred embodiment, the modular quick coupling device is a hoop type quick coupling device, and the hoop type quick coupling device includes a tubular hoop part and a protruding handle arranged at the end of the hoop.

As a preferred embodiment, the tube box in the modular heat exchange part is a cylindrical tube box and a circular tube plate adapted to its port contour. The tube sections connecting the cylindrical tube box and the circular tube plate are provided with external threads. In the hoop type quick coupling device, the segment type hoop is a tube section with internal threads adapted to the outer diameter of the tube box and the outer diameter of the tube plate respectively. The hoop type quick coupling device is sleeved at the tube mouth of the tube box, it is connected with its thread and moves along the axial direction of the header to connect or separate with the tube sheet.

As a preferred embodiment, the tube box in the modular heat exchange part is a rectangular cylindrical tube box, and a rectangular tube plate adapted to the contour of its port. The tube section type hoop in the hoop type quick coupling device is a rectangular tube section adapted to the outer diameter of the tube box and the outer contour of the tube plate, respectively. The hoop type quick coupling device is sleeved at the tube mouth of the tube box, and slides along the axial direction of the tube box to connect or separate from the tube plate.

As a preferred embodiment, the modular heat exchange part also includes a piece or a group of support tube sheet arranged along the axial direction of the heat exchange tube.

A cleaning device, including one or a group of cleaning containers, which are connected with one or a group of cleaning solution tanks and one or a group of pumps through pipelines, is characterized in that the inner cavity of the cleaning container also includes a fixing device for holding the modular horizontal tube evaporator unit as described previously, the fixing device comprises a clamping device for clamping and fixing the tube boxes or tube plates at both ends of the modular horizontal tube evaporator unit.

As a preferred embodiment, the inner cavity of the cleaning container is provided with a large number of inert solid particles for cleaning and descaling, the inlet and outlet of the cleaning container are provided with a mesh filtering device, and the mesh size of the mesh filtering device is smaller than the particle size of the inert solid particles.

As a preferred embodiment, the inert solid particles are spherical and flaky particles made of low hardness materials with certain density that are insoluble in cleaning solution and are not fragile.

As a preferred embodiment, the inert solid particles are prepared from ABS engineering plastics or resin materials.

As a preferred embodiment, the cleaning container is a vertical tank structure, with a cleaning solution inlet at one side of the lower end of the tank and a cleaning solution outlet at the other side of the upper end of the tank, which are respectively connected to the pipeline.

As a preferred embodiment, the cleaning container is a horizontal tank structure. A cleaning solution inlet is set at the lower end of one side of the tank, and a cleaning solution outlet is set at the upper end of the other side of the tank, which is respectively connected with the cleaning solution pipeline.

As a preferred embodiment, a cleaning agent is added to the cleaning solution.

A modular horizontal tube evaporator includes a horizontally arranged evaporator cylinder with evaporator components and spray components, which is characterized in that the evaporator components are one or more modular horizontal tube evaporator units as described previously.

As a preferred embodiment, the evaporator assembly includes modular horizontal tube evaporator units or modular horizontal tube evaporator unit sub-assemblies arranged in turn along the axial direction of the evaporator cylinder.

As a preferred embodiment, the modular horizontal tube evaporator unit is divided into a group of modular horizontal tube evaporator units arranged in a vertical direction.

As a preferred embodiment, the lower part or side of the evaporator barrel is provided with a cleaning hole for disassembling and replacing the modular horizontal tube evaporator unit.

As a preferred embodiment, the cleaning holes include the cleaning holes set separately for each modular horizontal tube evaporator unit or modular horizontal tube evaporator unit subassembly, or the cleaning holes are set separately according to the grouping of two or three or more adjacent modular horizontal tube evaporator units or modular horizontal tube evaporator unit subassembly.

As a preferred embodiment, the evaporator barrel includes a steam inlet component, which is connected with the steam inlet of each modular horizontal tube evaporator unit by pipeline.

As a preferred embodiment, the steam inlet assembly also includes one or a group of steam distribution center assemblies arranged inside or outside the evaporator barrel. The steam distribution center assembly includes a steam chamber for storing steam to be distributed, and the steam chamber is connected with the steam inlet of the nearby modular horizontal tube evaporator unit through a branch pipeline.

As a preferred embodiment, the evaporator barrel includes a steam exhaust component, the steam exhaust component includes one or more condensate collection pipes arranged at the lower part or lower side of the barrel inner cavity, and the condensate collection pipe is connected with the residual steam outlet of each modular horizontal tube evaporator unit through a pipeline.

The spraying component comprises a group of nozzles and is arranged above each modular horizontal tube evaporator unit.

The evaporator also comprises a secondary steam channel arranged in the cylinder, and a demister arranged on the upper part of the cylinder and above the secondary steam channel.

The secondary steam channel is arranged in the middle of the evaporator barrel.

A cleaning application method for modular horizontal tube evaporator, which is characterized in that when one or several modular horizontal tube evaporator units in the evaporator need to be cleaned due to scaling,
Step 1) Shut down the machine and open the cleaning hole corresponding to the modular horizontal tube evaporator unit or modular horizontal tube evaporator unit components to be cleaned;
Step 2) Remove the modular horizontal tube evaporator unit to be cleaned;
Step 3) Install the spare modular horizontal tube evaporator unit to the vacant place of the disassembled modular horizontal tube evaporator unit for replacement;
Step 4) After the replacement, start the machine and keep the evaporator running as a whole;
Step 5) Put the disassembled modular horizontal tube evaporator unit to be cleaned into the cleaning device as described in claim 7 in turn for cleaning and descaling;
Step 6) After drying the modular horizontal tube evaporator unit that has been cleaned and descaled, it will be used as a spare part for call in step 3).

The technical effect of the invention is:

The modular horizontal tube evaporator unit (hereinafter referred to as “modular unit”) of the invention includes a heat exchange part and a tube box at its end, and uses a modular quick connection device to realize the quick disassembly and connection of the heat exchange part and the tube box, and provides a modular steam inlet and exhaust interface in the tube box, so as to realize the “building block” splicing and expansion of the core components of the horizontal tube evaporator.

The invention aims at the technical dilemma that the heat exchange tubes in the evaporator are easy to scale and difficult to clean, and combines the technical concept of the “modular unit” of the invention to design a suitable cleaning device that can quickly and efficiently clean and remove the scale for the heat exchange unit equivalent to the “standardization”, and at the same time uses a new “cleaning agent inert solid particles”, combined with the cleaning method of agent circulation and inert solid particle turbulent collision, the comprehensive technical effect of rapid disassembly and connection of heat exchange unit and rapid and efficient cleaning of heat exchange unit can be achieved.

Based on the technical concept of “modular unit”, the invention adopts an evaporator cylinder. The “modular unit” can be spliced and extended by “building blocks”. The evaporator can realize “self-service” selection of the number of heat exchange units and splicing methods, and achieve the effect of selecting one set of equipment and multiple parameters. It improves the utilization rate of equipment, and can adjust equipment parameters according to different technical requirements, improve the adaptability of equipment, reduce the idleness of equipment technical performance, improve the production efficiency of the whole industry, and reduce production costs and energy consumption.

Based on the technical concept of “modular unit” and the quick disassembly and connection of the “heat exchange unit” in the evaporator, the invention can not only completely disassemble the “heat exchange units” in the evaporator, but also selectively disassemble the “heat exchange units” with serious scaling, and rapidly replace them with the standby “heat exchange units”, realizing the approximate “non-stop” disassembly and replacement of the “heat exchange units” to be cleaned, ensure the continuous and reliable operation of the evaporator as a whole, improve the utilization rate of existing equipment, significantly improve production efficiency, reduce operating costs, and have significant production and social benefits of energy conservation and consumption reduction.

The modular unit of the invention can take the evaporation efficiency of each evaporator unit as the basic design parameter of the modular unit, or take the length of the evaporator unit or the maximum pipe diameter as the basic design parameter. This basic design parameter will bring great convenience to the practical application. In actual use, the number of modular units set in the evaporator can be increased or reduced at any time according to the actual needs, the number of modular units set can be estimated in advance according to the design parameters of modular units, and the required spare modular units can be accurately estimated for replacement.

With reference to the following description, these and other features, aspects and advantages of the present application will become better understood. The accompanying drawings in and forming a part of this specification describe embodiments of the application, and are used to explain the principle of the application together with the description.

### DESCRIPTION OF ATTACHED DRAWINGS

FIG. 1 shows the structural diagram of an embodiment of the modular horizontal tube evaporator unit of the invention.

FIG. 2 shows the structural diagram of one embodiment of the modular evaporator of the invention.

FIG. 3 shows the structure diagram of the cleaning device of the invention.

FIG. 4 shows the comparison diagram of cleaning efficiency of the cleaning device shown in FIG. 3.

The drawing marks are listed as follows:

1 steam exhaust hole, 2 pipe box, 3 quick connector, 4 tube plate, 5 heat exchange tube, 6 condensate outlet, 20 end side cover plate, 21 modular unit, 22 cylinder, 23 nozzle, 24 cleaning hole, 25 intermediate secondary steam separator, 26 demister, 27 support plate, 28 residual steam collection pipe, 29 condensate collection pipe, 40 reagent and detergent tank, 41 circulating pump, 42 filter screen, 43 modular unit cleaner, 44 inert solid particles.

### SPECIFIC EMBODIMENTS

One or more examples of the embodiments of the application will be described in the figure with reference to the embodiments of the application in detail. Each example is provided for the purpose of explaining the application, not limiting the application. In fact, those skilled in the art will know that various modifications and changes can be made in the application without departing from the scope or spirit of the application. For example, features described or described as part of one embodiment may be used with another embodiment to generate another embodiment. Therefore, it is hoped that this application covers such modifications and changes, which are within the scope of the appended claims and their equivalents. As used in this manual, the terms “first”, “second”, etc. can be interchangeably used to distinguish one component from another rather than to indicate the position or importance of each component. As used in the specification, the terms “one”, “one”, “the” and “the” are intended to indicate the presence of one or more elements unless the context expressly indicates otherwise. The terms “including”, “including”, and “having” are intended to be inclusive and imply that there may be other elements in addition to those listed.

Refer to the drawings, where the same number in all drawings represents the same element, and the invention will be further explained in combination with specific embodiments.

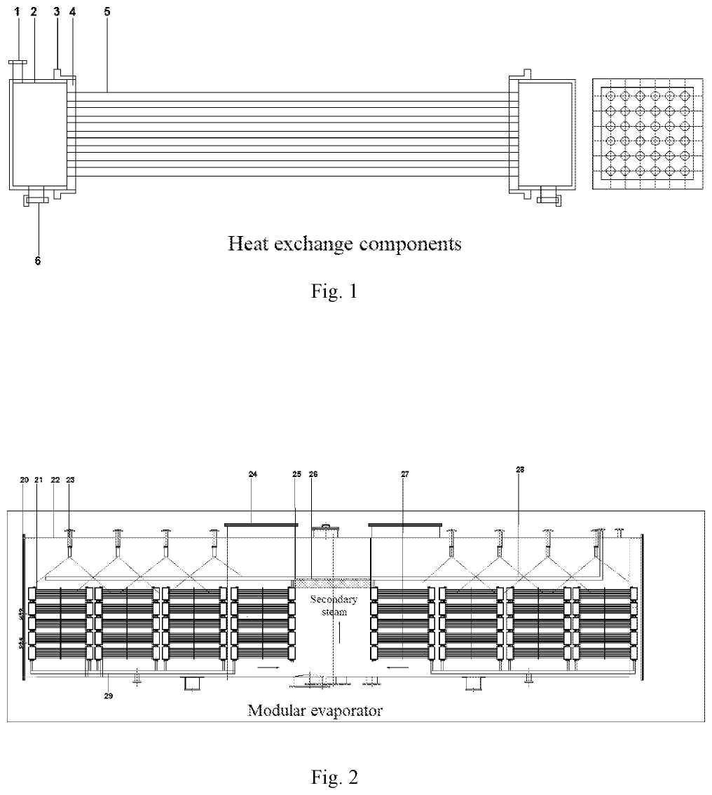

FIG. 1 shows the structural diagram of an embodiment of the modular horizontal tube evaporator unit of the invention.

In this embodiment, the modular unit is in double header mode.

The heat exchange tube assembly comprises a heat exchange tube bundle 5 and a tube sheet 4 at both ends of the heat exchange tube bundle 5. The tube sheet 4 is arranged with a tube hole group as shown in the right-side view in the figure. Two pairs of heat exchange tubes are correspondingly inserted into the tube holes of the tube sheet 4 to form a heat exchange tube assembly.

The tube sheet 4 at both ends of the heat exchange tube assembly is correspondingly equipped with a tube box 2. One side of the tube box 2 is set with a steam inlet as the steam inlet end, and the other side of the tube box 2 is set with a residual steam exhaust end. The side wall is set with a residual steam exhaust port 1 and a condensate outlet 6.

The connection between the tube box 2 and the tube plate 4 is provided with a quick connector 3. In this embodiment, the tube box 2 and the tube plate 4 are both rectangular cross-section tube sections, and the quick connector 3 has a rectangular internal section corresponding to it. The quick connector 3 is sleeved on the outside of the tube section of the tube box 2 and can slide along the axis of the tube box 2. After the quick connector 3 slides along the axis of the tube box 2 and is sleeved on the tube plate 4, the assembly of the tube box 2 and the heat exchange tube assembly can be completed by fastening the attached fastener with the heat exchange tube assembly, reverse the disassembly of the heat exchange tube assembly.

As another embodiment, the tube box 2 and the tube plate 4 can also be circular cross-section pipe sections, and the quick connector 3 has a circular pipe section with a circular internal section that matches with them. In this case, the inner pipe surface of the quick connector 3 can be provided with threads, the outer sides of the circular pipe sections of the tube box 2 and the tube plate 4 are also provided with threads that match with them, and the quick connector 3 is sleeved on the outer side of the pipe section of the tube box 2 through the threads and can move along its axis, finally, the tube box 2 and the heat exchange tube assembly are assembled or disassembled by rotating and moving with the external thread of the tube plate 4.

In order to facilitate operation, one end of the quick connector 3 can be attached with a protruding handle.

FIG. 2 shows the structural diagram of one embodiment of the modular evaporator of the invention.

A long cylinder 22 is horizontally arranged, and end side cover plates 20 are arranged at both ends of the cylinder 22. Several groups of modular unit groups are arranged in the inner cavity of the cylinder 22 along the axial direction of the cylinder 22. Each group of modular unit groups includes several modular units 21. Each modular unit 21 in the group is arranged in a vertical direction, and one or a group of support plates 27 are arranged in the middle of the heat exchange tube bundle of each modular unit to improve the rigidity of the heat exchange components, avoid failure caused by deformation of slender tube.

As an alternative grouping arrangement, the modular unit grouping of the present invention can also adopt a single modular unit, a dual modular unit, a three modular unit or a combination of more modular units, and the arrangement of the modular units in each grouping need not be limited to the sequential arrangement in the vertical direction in the figure, but can also adopt a horizontal or vertical arrangement, or the vertical and horizontal directions are combined.

In order to facilitate the disassembly and assembly of modular units, one or more cleaning holes 24 are arranged along the axial direction of the barrel 22. The cleaning holes can be arranged at the lower part of the barrel, or at the side lower part or middle part of the barrel according to the radial size of the barrel or the arrangement of modular units.

When one or more heat exchange tube assemblies fail or fail due to scaling or other reasons, the cleaning hole 24 corresponding to its position can be opened to quickly disassemble the heat exchange tube assembly or the modular unit, and the spare heat exchange tube assembly or modular unit assembly can be used instead to ensure the rapid recovery of the entire evaporator unit.

In the inner cavity of the cylinder 22, a group of nozzles 23 are arranged above the modular unit. The nozzles 23 are connected with the sewage inlet pipe, and the sewage is evenly sprayed on each heat exchange tube assembly. The steam inlet end of each modular unit is connected with the steam inlet pipe, and the residual steam exhaust end is connected with the residual steam collection pipe 28 and the condensate collection pipe 29, respectively, to discharge the residual steam and condensate.

As a preferred embodiment, the residual steam collection pipe 28 is arranged at the upper part of the barrel 22, and the condensate collection pipe 29 is arranged at the lower part of the barrel 22. As an optional embodiment, the steam collection pipe 28 and the condensate collection pipe 29 can also be arranged at other positions of the barrel 22, such as the middle side or the lower side of the barrel 22.

The upper space of the barrel 22 is also provided with a middle secondary steam partition plate 25, and a secondary steam channel and a demister 26 are reserved.

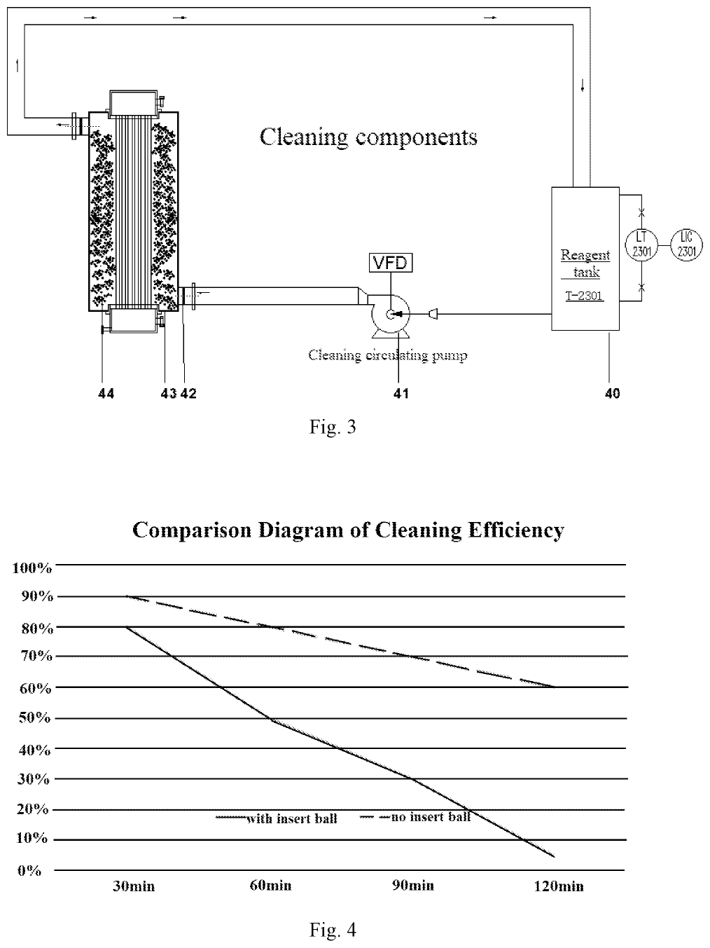

FIG. 3 shows the structure diagram of the cleaning device of the invention.

The cleaning device comprises an agent and a cleaning solution tank 40, a circulating pump 41 and a modular unit cleaner 43 which are sequentially connected by the pipeline.

As shown in the figure, the modular unit cleaner 43 is a vertical tank structure, with a cleaning solution inlet set at the lower side of the tank and a cleaning solution outlet set at the other side of the upper side of the tank, which are connected to the pipeline respectively.

As another preferred embodiment, the modular unit cleaner 43 can also be a horizontal tank structure, with a cleaning solution inlet set at the lower end of one side of the tank and a cleaning solution outlet set at the upper end of the other side, which are connected to the pipeline respectively.

When the modular unit 21 needs to be cleaned due to scaling, quickly disassemble the modular unit 21 and quickly install it onto the modular unit cleaner 43. After the agent and cleaning solution tank 40 are prepared with the agent required for cleaning, start the circulating pump 41, which pumps the cleaning solution containing the agent into the modular unit cleaner 43. The cleaning solution circulates back to the agent and cleaning solution tank 40 through the liquid outlet, and then circulates for cleaning.

Inert solid particles 44 are scattered in the cavity of the modular unit cleaner 43. The cleaning solution forms turbulence in the cleaning cavity. Inert solid particles 44 hit the surface of the heat exchange tube with the turbulence, thus accelerating the cleaning of the scaling on the surface of the heat exchange tube. A filter screen 42 is installed at the inlet and outlet of the cleaning cavity. The mesh size of the filter screen is smaller than the particle size of the inert solid particles 44, which limits the escape of the inert solid particles 44 and ensures that they can only move in the cavity of the modular unit cleaner 43.

FIG. 4 shows the efficiency comparison between the cleaning method with inert solid particles and the cleaning method without inert solid particles.

The experiment proves that after adding inert solid particles, only 5% of the residual fouling of the heat exchange tube remains after 120 min of cleaning. Without inert solid particles, about 60% of the residual fouling of the heat exchange tube remains after 120 min of cleaning. Obviously, adding inert solid particles can significantly accelerate the cleaning of the heat exchange components and greatly improve the cleaning effect.

According to the technical principle of the invention, the inert solid particles are preferably spherical and flaky particles prepared from low hardness materials that are insoluble in the cleaning solution and are not fragile and have appropriate density.

As a preferred embodiment, the inert solid particles in this embodiment are preferably prepared from ABS engineering plastics or resin materials. However, this choice does not mean that other known materials with the same or similar properties are excluded from the protection scope of the invention.

The invention also provides a preferred cleaning application method for a modular horizontal tube evaporator, and the specific steps include: when one or several modular units in the evaporator are scaling and need to be cleaned
Step 1) Stop the machine and open the cleaning hole corresponding to the modular unit or modular unit component to be cleaned;
Step 2) Remove the modular unit to be cleaned;
Step 3) Install the spare modular unit to the vacant place of the disassembled modular unit for replacement;
Step 4) After the replacement, start the machine and keep the evaporator running as a whole;
Step 5) Put the disassembled modular horizontal tube evaporator units to be cleaned into the cleaning device in turn for cleaning and descaling;
Step 6) After drying the modular unit that has been cleaned and descaled, it will be used as a spare part for call in Step 3).

This cleaning application method, on the one hand, can quickly remove, replace and install modular units, and timely send modular units with serious structure to clean and descale; On the other hand, it can greatly shorten the downtime, improve the attendance rate of equipment, avoid the decline in efficiency and increase in cost caused by idle equipment, and has the technical and social benefits of high efficiency, energy conservation and consumption reduction.

The above is the preferred embodiment of the invention. For those skilled in the art, based on the technical solution and essence of the invention, other modifications and improvements can be made, but these modifications and improvements based on the invention should be covered in the protection scope of the invention.

The specification uses embodiments to disclose the application, including best embodiments, and enables those skilled in the art to practice the application, including manufacturing and using any device or system and performing any incorporated method. The patentable scope of the present application is defined by the claims, and may include other embodiments thought of by those skilled in the art. If such other embodiments include structural elements that are not different from the literal language of the claims, or if they include equivalent structural elements that are not substantially different from the literal language of the claims, they are established within the scope of the claims.

1. A modular horizontal tube evaporator unit is characterized in that the modular horizontal tube evaporator unit at least includes
Modular heat exchange part, at least one tube plate is respectively arranged at both ends of the modular heat exchange part, a group of tube holes are arranged on the tube plates at both ends of the heat exchange part, the heat exchange part also includes a group of heat exchange tubes, and both ends of the heat exchange tubes are respectively arranged in the tube holes;
A modular header is arranged at one or both ends of the modular heat exchange part, and at least a steam inlet and a condensate and/or residual steam outlet are arranged on the modular header;
The modular quick connection device is used to connect the modular header and the tube sheet of the modular heat exchange part connected with the modular quick connection device.

2. The modular horizontal tube evaporator unit as claimed in claim 1, which is characterized in that the specific technical parameters include any one or two or three of the heat transfer power or axial length or maximum radial dimension.

3. The modular horizontal tube evaporator unit as claimed in claim 1, which is characterized in that the modular horizontal tube evaporator unit includes a single modular header mode, the single modular header is set at one end of the modular heat exchange part, and the inner cavity of the modular header is sealed and isolated as a steam inlet part and a steam outlet part.

4. The modular horizontal tube evaporator unit as claimed in claim 1, which is characterized in that the modular evaporator unit includes a dual modular tube box mode, wherein the dual modular tube box is respectively arranged at both ends of the modular heat exchange part, wherein one tube box is a steam inlet tube box, and the other tube box is a steam outlet tube box, and the condensate water and/or residual steam outlet are arranged.

5. The modular horizontal tube evaporator unit as claimed in claim 1, which is characterized in that the modular quick coupling device is a hoop type quick coupling device, and the hoop type quick coupling device includes a tubular hoop part and a protruding handle arranged at the end of the hoop.

6. The modular horizontal tube evaporator unit as claimed in claim 5, which is characterized in that the tube box of the modular heat exchange part is a cylindrical tube box and a circular tube plate adapted to its port contour, the tube sections connecting the cylindrical tube box and the circular tube plate are provided with external threads, and the tube section type hoop in the hoop type quick coupling device is a tube section with internal threads adapted to the outer diameter of the tube box and the outer diameter of the tube plate, respectively, the ferrule type quick coupling device is sleeved at the pipe mouth of the pipe box and connected with its thread, and moves along the axial direction of the pipe box to connect or separate with the pipe plate.

7. The modular horizontal tube evaporator unit as claimed in claim 5, which is characterized in that the tube box in the modular heat exchange part is a rectangular cylindrical tube box and a rectangular tube plate adapted to the contour of its port, the tube section type hoop in the hoop type quick coupling device is a rectangular tube section adapted to the outer diameter of the tube box and the outer contour of the tube plate, and the hoop type quick coupling device is sleeved at the tube mouth of the tube box, and slide along the axial direction of the header to connect or separate it from the tube sheet.

8. The modular horizontal tube evaporator unit as claimed in claim 1, which is characterized in that the modular heat exchange part also includes a piece or a group of support tube sheet arranged along the axial direction of the heat exchange tube.

9. A cleaning device, including one or a group of cleaning containers, which are connected with one or a group of cleaning solution tanks and one or a group of pumps through pipelines, is characterized in that the inner cavity of the cleaning container also includes a fixed device for holding the modular horizontal tube evaporator unit as claimed in claim 1, the fixing device comprises a clamping device for clamping and fixing the tube boxes or tube plates at both ends of the modular horizontal tube evaporator unit.

10. The cleaning device as claimed in claim 9, which is characterized in that a large number of inert solid particles for cleaning and descaling are arranged in the inner cavity of the cleaning container, and a mesh filter device is arranged at the inlet and outlet of the cleaning container, and the mesh size of the mesh filter device is smaller than the particle size of the inert solid particles.

11. The cleaning device as claimed in claim 10, which is characterized in that the inert solid particles are spherical and flaky particles made of low hardness materials with a certain density that are insoluble in the cleaning solution and are not fragile.

12. The cleaning device as claimed in claim 11, which is characterized in that the inert solid particles are made of ABS engineering plastics or resin materials.

13. The cleaning device as claimed in claim 9, which is characterized in that the cleaning container is a vertical tank structure, with a cleaning solution inlet at one side of the lower end of the tank and a cleaning solution outlet at the other side of the upper end of the tank, which are respectively connected with the pipeline.

14. The cleaning device as claimed in claim 9, which is characterized in that the cleaning container is a horizontal tank structure, the lower end of one side of the tank is provided with a cleaning solution inlet, and the upper end of the other side of the tank is provided with a cleaning solution outlet, which are respectively connected with the cleaning solution pipeline.

15. The cleaning device according to claim 9, which is characterized in that the cleaning solution is added with a cleaning solution.

16. A modular horizontal tube evaporator includes a horizontally arranged evaporator cylinder, in which evaporator components and spray components are arranged, which is characterized in that the evaporator components are one or more modular horizontal tube evaporator units as described in claim 1.

17. The modular horizontal tube evaporator as claimed in claim 16, which is characterized in that the evaporator assembly includes modular horizontal tube evaporator units or modular horizontal tube evaporator unit sub-assemblies arranged in turn along the axial direction of the evaporator cylinder.

18. The modular horizontal tube evaporator as claimed in claim 17, which is characterized in that the modular horizontal tube evaporator unit is divided into a group of modular horizontal tube evaporator units arranged in a vertical direction.

19. The modular horizontal tube evaporator as claimed in claim 16, which is characterized in that the lower part or side of the evaporator barrel is provided with a cleaning hole for disassembling and replacing the modular horizontal tube evaporator unit.

20. The modular horizontal tube evaporators as claimed in claim 19, which is characterized in that the cleaning holes include the cleaning holes set separately for each modular horizontal tube evaporator unit or modular horizontal tube evaporator unit sub assembly, or the cleaning holes are set separately according to the grouping of two or three or more adjacent modular horizontal tube evaporator units or modular horizontal tube evaporator unit sub-assemblies.

21. The modular horizontal tube evaporators as claimed in claim which is characterized in that the evaporator barrel includes a steam inlet component, and the steam inlet component is connected with the steam inlet of each modular horizontal tube evaporator unit by pipeline.

22. The modular horizontal tube evaporator as claimed in claim 21, which is characterized in that the steam inlet assembly also includes one or a group of steam distribution center assemblies arranged in or outside the evaporator cylinder, the steam distribution center assembly includes a steam chamber for storing steam to be distributed, and the steam chamber is connected with the steam inlet of the modular horizontal tube evaporator unit nearby through a branch pipeline.

23. The modular horizontal tube evaporator as claimed in claim 22, which is characterized in that the evaporator barrel includes a steam exhaust component, the steam exhaust component includes one or more condensate collection pipes arranged at the lower part or the lower side of the barrel cavity, and the condensate collection pipe is connected with the residual steam outlet of each modular horizontal tube evaporator unit through a pipeline.

24. The modular horizontal tube evaporator as claimed in claim 23, which is characterized in that the spray component comprises a group of nozzles and is arranged above each modular horizontal tube evaporator unit.

25. The modular horizontal tube evaporator as claimed in claim 24, which is characterized in that the evaporator also includes a secondary steam channel arranged in the cylinder and a demister arranged on the upper part of the cylinder and above the secondary steam channel.

26. The modular horizontal tube evaporator as claimed in claim which is characterized in that the secondary steam channel is arranged in the middle of the evaporator barrel.

27. A cleaning application method for modular horizontal tube evaporator, which is characterized in that when one or several modular horizontal tube evaporator units in the evaporator are scaling and need to be cleaned,
Step 1) Shut down the machine and open the cleaning hole corresponding to the modular horizontal tube evaporator unit or modular horizontal tube evaporator unit components to be cleaned;
Step 2) Remove the modular horizontal tube evaporator unit to be cleaned;
Step 3) Install the spare modular horizontal tube evaporator unit to the vacant place of the disassembled modular horizontal tube evaporator unit for replacement;
Step 4) After the replacement, start the machine and keep the evaporator running as a whole;
Step 5) Put the disassembled modular horizontal tube evaporator unit to be cleaned into the cleaning device as described in claim 9 in order to clean and descale;
Step 6) After drying the modular horizontal tube evaporator unit that has been cleaned and descaled, it will be used as a spare part for call in step 3).
